(19) United States
(12) Patent Application Publication
(10) Pub. No.: US 2025/0233195 A1
(43) Pub. Date: Jul. 17, 2025

(54) LITHIUM-ION CELL

(71) Applicant: VARTA Microbattery GmbH, Ellwangen Jagst (DE)

(72) Inventors: Stefanie SCHOLZ, Ellwangen (DE); Edward PYTLIK, Ellwangen (DE); David ENSLING, Ellwangen (DE); Ihor CHUMAK, Ellwangen (DE)

(21) Appl. No.: 18/702,806

(22) PCT Filed: Oct. 13, 2022
(86) PCT No.: PCT/EP2022/078566

§ 371 Date: Apr. 19, 2024

(30) Foreign Application Priority Data
Oct. 20, 2021 (EP) 21203827.7

(51) Int. Cl. H01M 10/0525; H01M 4/02; H01M 4/131; H01M 4/485; H01M 4/505; H01M 4/62; H01M 4/66; H01M 10/0567; H01M 10/0568; H01M 10/0569; H01M 50/46

(52) U.S. Cl. CPC H01M 10/0525; H01M 4/131; H01M 4/485; H01M 4/505; H01M 4/622; H01M 4/625; H01M 4/662; H01M 10/0567; H01M 10/0568; H01M 10/0569; H01M 50/46; H01M 2004/021; H01M 2004/027; H01M 2004/028; H01M 2300/004

(57) ABSTRACT

A secondary lithium-ion cell includes an anode having a negative electrode material and a current collector with a strip-shaped main region loaded with a layer of the negative electrode material and a free edge strip not loaded with the negative electrode material. The cell further includes a cathode having a positive electrode material and a current collector with a strip-shaped main region loaded with a layer of the positive electrode material and a free edge strip that is not loaded with the positive electrode material. The cell additionally includes a sheet metal member contacting one of the free edge strips. The anode and the cathode are provided in an electrode-separator assembly with a sequence anode/separator/cathode, the electrode-separator assembly forming a coil with two terminal end faces enclosed in a housing. The negative electrode includes lithium titanate (LTO), and the positive electrode includes lithium manganese oxide (LMO).

### CROSS REFERENCE TO RELATED APPLICATIONS

This application is a U.S. National Phase application under 35 U.S.C. § 371 of International Application No. PCT/EP2022/078566, filed on Oct. 13, 2022, and claims benefit to European Patent Application No. EP 21203827.7, filed on Oct. 20, 2021. The International Application was published in German on Apr. 27, 2023 as WO/2023/066791 A1 under PCT Article 21(2).

### FIELD

The present disclosure relates to a secondary lithium-ion cell.

### BACKGROUND

Electrochemical cells are capable of converting stored chemical energy into electrical energy through a redox reaction. They usually comprise a positive and a negative electrode, which are separated from each other by a separator. During a discharge, electrons are released at the negative electrode through an oxidation process. This results in an electron current that can be tapped by an external electrical consumer, for which the electrochemical cell serves as an energy supplier. At the same time, an ion current corresponding to the electrode reaction occurs within the cell. This ion current passes through the separator and is made possible by an ion-conducting electrolyte.

If the discharge is reversible, i.e. it is possible to reverse the conversion of chemical energy into electrical energy during discharge and thus charge the cell again, this is referred to as a secondary cell. The common designation of the negative electrode as the anode and the designation of the positive electrode as the cathode in secondary cells refers to the discharge function of the electrochemical cell.

Today, secondary lithium-ion cells are used for many applications, as they can provide high currents and are characterized by a comparatively high energy density. They are based on the use of lithium, which can move back and forth between the electrodes of the cell in the form of ions. The negative electrode and the positive electrode of a lithium-ion cell are usually formed by so-called composite electrodes, which include electrochemically inactive components as well as electrochemically active components.

In principle, all materials that can absorb and release lithium ions can be used as electrochemically active components (active materials) for secondary lithium-ion cells. Carbon-based particles, such as graphitic carbon, are often used for the negative electrode. Other, non-graphitic carbon materials that are suitable for the intercalation of lithium, such as lithium titanate (LTO), can also be used. In addition, metallic and semi-metallic materials that can be alloyed with lithium can also be used. For example, the elements tin, aluminum, antimony and silicon are able to form intermetallic phases with lithium. Lithium metal oxides such as lithium cobalt oxide (LiCoO₂) and lithium manganese oxide (LMO), lithium iron phosphate (LiFePO₄) or derivatives thereof can be used as active materials for the positive electrode. The electrochemically active materials are usually contained in the electrodes in particle form.

As electrochemically inactive components, the composite electrodes generally comprise a flat and/or strip-shaped current collector, for example a metallic foil, which serves as a carrier for the respective active material. The current collector for the negative electrode (anode current collector) can be made of copper or nickel, for example, and the current collector for the positive electrode (cathode current collector) can be made of aluminum, for example. Furthermore, the electrodes can comprise an electrode binder (e.g. polyvinylidene fluoride (PVDF) or another polymer, for example carboxymethyl cellulose), conductivity-improving additives and other additives as electrochemically inactive components. The electrode binder ensures the mechanical stability of the electrodes and often also the adhesion of the active material to the current collectors.

The electrolytes used in lithium-ion cells are usually solutions of lithium salts such as lithium hexafluorophosphate (LiPF₆) in organic solvents (e.g. ethers and esters of carbonic acid).

The composite electrodes are combined with one or more separators to form an assembly during the production of a lithium-ion cell. In this process, the electrodes and separators are joined together, usually under pressure, and sometimes also by lamination or bonding. The basic functionality of the cell can then be established by impregnating the assembly with the electrolyte.

In many embodiments, the assembly is formed in the form of a coil or processed into a coil. As a rule, it comprises the sequence positive electrode/separator/negative electrode. Assemblies are often produced as so-called bi-cells with the possible sequences negative electrode/separator/positive electrode/separator/negative electrode or positive electrode/separator/negative electrode/separator/positive electrode.

For applications in the automotive sector, for e-bikes or for other applications with high energy requirements, such as in tools, lithium-ion cells with the highest possible energy density are required that are also capable of withstanding high currents during charging and discharging.

Cells for the applications mentioned are often designed as cylindrical round cells, for example with a form factor of 21×70 (diameter times height in mm). Cells of this type always include an assembly in the form of a winding. Modern lithium-ion cells of this form factor can already achieve an energy density of up to 270 Wh/kg. However, this energy density is only regarded as an intermediate step. The market is already demanding cells with even higher energy densities.

When developing improved electrochemical cells, however, there are other factors to consider than just energy density. Extremely important parameters are also the internal resistance of the cells, which should be kept as low as possible in order to reduce power losses during charging and discharging, as well as the thermal connection of the electrodes, which can be essential for regulating the temperature of the cell. These parameters are also very important for cylindrical round cells that contain an assembly in the form of a coil. When cells are fast-charged, heat build-up can occur in the cells due to power losses, which can lead to massive thermomechanical stresses and subsequently to deformation and damage to the cell structure. The risk is increased if the electrical connection of the current collectors is made via separate, electrically conductive arrester tabs welded to the current collectors, which emerge axially from wound assemblies, as heating can occur locally at these arrester tabs under heavy loads during charging or discharging. Such arrester tabs can be strips of thin, a few mm wide metal foil, for example.

WO 2017/215900 A1 describes cells in which the electrode-separator assembly and its electrodes are ribbon-shaped and in the form of a coil. The electrodes each have current collectors loaded with electrode material. Oppositely polarized electrodes are arranged offset to each other within the electrode-separator assembly so that longitudinal edges of the current collectors of the positive electrodes emerge from the coil on one side and longitudinal edges of the current collectors of the negative electrodes emerge from the coil on another side. For electrical contacting of the current collectors, the cell has at least one contact sheet metal member that rests on one of the longitudinal edges in such a way that a line-like contact zone is formed. The contact sheet metal member is connected to the longitudinal edge along the linear contact zone by welding. This makes it possible to electrically contact the current collector and thus also the associated electrode over its entire length. This significantly reduces the internal resistance within the cell described. As a result, the occurrence of large currents can be absorbed much better.

### SUMMARY

In an embodiment, the present disclosure provides a secondary lithium-ion cell. The secondary lithium ion cell includes a ribbon-shaped anode having a negative electrode material and a ribbon-shaped anode current collector. The anode current collector includes a first longitudinal edge, a second longitudinal edge, a strip-shaped main region loaded with a layer of the negative electrode material, and a free edge strip that extends along the first longitudinal edge and is not loaded with the negative electrode material. The secondary lithium ion cell further includes a ribbon shaped cathode having a positive electrode material and a ribbon-shaped cathode current collector. The cathode current collector includes a first longitudinal edge, a second longitudinal edge, a strip-shaped main region loaded with a layer of the positive electrode material, and a free edge strip that extends along the first longitudinal edge and is not loaded with the positive electrode material. The secondary lithium ion cell additionally includes a contact sheet metal member in direct contact with the free edge strip of the anode current collector or with the free edge strip of the cathode current collector. The anode and the cathode are provided in an electrode-separator assembly with a sequence anode/separator/cathode, the electrode-separator assembly forming a coil with two terminal end faces and being enclosed in a housing. The anode and the cathode are arranged within the electrode-separator assembly such that the free edge strip of the anode current collector emerges from one of the terminal end faces and the free edge strip of the cathode current collector emerges from the other of the terminal end faces. The negative electrode material comprises lithium titanate (LTO), and the positive electrode material comprises lithium manganese oxide (LMO).

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a top view of a current collector in an embodiment;

FIG. 2 shows a sectional view of the current collector shown in FIG. 1;

FIG. 3 shows a top view of an anode that can be processed into an electrode-separator assembly in the form of a coil;

FIG. 4 is a sectional view of the anode shown in FIG. 3;

FIG. 5 shows a top view of an electrode-separator assembly manufactured using the anode shown in FIG. 3;

FIG. 6 is a sectional view of the electrode-separator assembly shown in FIG. 5;

FIG. 7 shows various embodiments of a contact sheet metal member or a cover assembly of a cell (cross-sectional views);

FIG. 8 is a partial representation of an embodiment of a cell (cross-sectional view);

FIG. 9 is a partial representation of a further embodiment of a cell (cross-sectional view);

FIG. 10 is a representation of a further embodiment of a cell (cross-sectional view);

FIG. 11 is an illustration of a further embodiment of a cell (cross-sectional view); and

FIG. 12 provides graphical representations of the results of three cyclization tests.

### DETAILED DESCRIPTION

The present disclosure provides lithium-ion cells characterized by an improved energy density compared to the state of the art and which at the same time have excellent characteristics with regard to their internal resistance and their passive heat dissipation capabilities.

A secondary lithium-ion cell according to the disclosure has the immediately following features a. to k:
a. the cell comprises an electrode-separator assembly with the sequence anode/separator/cathode,
b. the anode is ribbon-shaped and comprises a negative electrode material and a ribbon-shaped anode current collector with a first longitudinal edge and a second longitudinal edge,
c. the anode current collector has a strip-shaped main region which is loaded with a layer of the negative electrode material and a free edge strip which extends along the first longitudinal edge and which is not loaded with the electrode material,
d. the cathode is ribbon-shaped and comprises a positive electrode material and a ribbon-shaped cathode current collector with a first longitudinal edge and a second longitudinal edge,
e. the cathode current collector has a strip-shaped main region which is loaded with a layer of the positive electrode material and a free edge strip which extends along the first longitudinal edge and which is not loaded with the electrode material,
f. the electrode-separator assembly is in the form of a coil with two end faces,
g. the electrode-separator assembly is enclosed in a housing,
h. the anode and the cathode are designed and/or arranged within the electrode-separator assembly in such a way that the free edge strip of the anode current collector emerges from one of the terminal end faces and the free edge strip of the cathode current collector emerges from the other of the terminal end faces,
i. the cell has a contact sheet metal member which is in direct contact with one of the edge strips, preferably directly connected to this edge strip by welding or soldering,
j. the layer of negative electrode material comprises lithium titanate (LTO) and
k. the layer of positive electrode material comprises lithium manganese oxide (LMO).

To clarify, the connection between the contact sheet metal member and the edge strips of the anode current collectors or the cathode current collectors is a direct one. In the case of welding, the contact sheet metal member is fused directly to the free edge strips, whereas in the case of soldering, at most a thin layer of solder metal is arranged between the contact sheet metal member and the free edge strips.

The direct connection of the contact sheet metal member to the current collectors of the electrodes can ensure excellent heat dissipation properties, which will be explained below.

Furthermore: The free edge strips that extend along the first longitudinal edges encompass these longitudinal edges. The first longitudinal edges are therefore to be regarded as part of the respective edge strips.

### Electrochemical System

The cell is designed as a lithium-ion cell, i.e. it has electrodes that can reversibly absorb and release lithium. The LTO in the negative electrode and the LMO in the positive electrode are used for this purpose.

LMO has been known for some time as an electrode material for the positive electrodes of lithium-ion batteries. It has a spinel structure similar to that of the naturally occurring mineral MgAl₂O₄.

LTO has also been known for some time as an electrode material for the negative electrodes of lithium-ion batteries. It is also available in a spinel structure.

An overview of suitable lithium manganese spinel compounds and suitable lithium titanate compounds can be found in the following: J. B. Goodenough/Journal of Power Sources 174 (2007) 996-1000; Zaghib et al./Materials 2013, 6, 1028-1049; and Lin et al./Journal of Power Sources 248 (2014) 1034-1041.

A particular advantage is that the combination of electrode materials (LTO/LMO) enables voltage compatibility with conventional supercapacitors. The cell preferably has a nominal voltage in the range of 2.2-3.0 V, in particular 2.7 V, at room temperature. Cells with such a voltage window can replace supercapacitors in corresponding applications, but have a much higher capacity. The combination of the aforementioned combination of electrode materials and the contacting of the current collectors by means of the contact sheet metal member gives the cell a surprisingly good high-current capability, especially in the charging direction and also at low temperatures (<10° C.).

### Preferred Cathode-Side Structure

In a preferred embodiment, the cathode of the cell is characterized by at least one of the immediately following additional features a. to d.:
a. The positive electrode material comprises the LMO in a proportion of 70 wt. % to 99.4 wt. %.
b. The positive electrode material comprises an electrode binder and/or a conductive agent.
c. The electrode binder is contained in the positive electrode material in a proportion of 0.5% to 15% by weight.
d. The conductive agent is contained in the positive electrode material in a proportion of 0.1% to 15% by weight.

Preferably, the immediately preceding additional features a. to d. are realized in combination.

The percentages refer to the dry mass of the electrode material, i.e. the electrode material excluding electrolyte.

The active materials of the cathode are preferably embedded in a matrix of the electrode binder, whereby neighboring particles in the matrix are preferably in direct contact with each other. Conductive agents are used to increase the electrical conductivity of the electrodes. Common electrode binders are based on polyvinylidene fluoride (PVDF), polyacrylate styrene-butadiene-rubber (SBR) or carboxymethyl cellulose, for example. Common conductive agents are carbon black, graphite, graphene, carbon nanofibers and metal powder.

Preferably, the layer of positive electrode material on the cathode current collector has a thickness in the range of 20 μm to 300 μm.

### Preferred Anode-Side Structure

In a preferred embodiment, the anode of the cell is characterized by at least one of the immediately following additional features a. to d.:
a. The negative electrode material comprises the LTO in a proportion of 70% to 99.4% by weight.
b. The negative electrode material comprises an electrode binder and/or a conductive agent.
c. The electrode binder is contained in the negative electrode material in a proportion of 0.5% to 15% by weight.
d. The conductive agent is contained in the negative electrode material in a proportion of 0.1% to 15% by weight.

Preferably, the immediately preceding additional features a. to d. are realized in combination.

The percentages here also refer to the dry mass of the electrode material, i.e. the electrode material excluding electrolyte.

The active materials of the anode are preferably embedded in a matrix of the electrode binder, whereby neighboring particles in the matrix are preferably in direct contact with each other. Conductive agents are used to increase the electrical conductivity of the electrodes. Common electrode binders are based on polyvinylidene fluoride (PVDF), polyacrylate styrene-butadiene-rubber (SBR) or carboxymethyl cellulose, for example. Common conductive agents are carbon black, graphite, graphene, carbon nanofibers and metal powder.

Preferably, the layer of negative electrode material on the anode current collector has a thickness in the range of 20 μm to 300 μm.

### Separator

The electrode-separator assembly preferably comprises at least one ribbon-shaped separator, preferably two ribbon-shaped separators, each of which has a first and a second longitudinal edge and two ends.

The separators are preferably formed from electrically insulating plastic films. It is preferable that the separators can be penetrated by a liquid electrolyte. For this purpose, the plastic films used can have pores, for example. The film can be made of a polyolefin or a polyether ketone, for example. Nonwovens and fabrics made of plastic materials or other electrically insulating fabrics can also be used as separators. Separators with a thickness in the range of 5 μm to 50 μm are preferred.

The separators are impregnated with a liquid electrolyte for operation.

However, as an alternative to a separator-liquid electrolyte combination, the cell can also have a solid-state electrolyte, for example.

The solid-state electrolyte is preferably a polymer solid-state electrolyte based on a polymer-conducting salt complex, which is present in a single phase without any liquid component. A polymer solid-state electrolyte can have polyacrylic acid (PAA), polyethylene glycol (PEG) or polymethyl methacrylate (PMMA) as the polymer matrix. Lithium conductive salts such as lithium bis-(trifluoromethane)sulfonylimide (LiTFSI), lithium hexafluorophosphate (LiPF₆) and lithium tetrafluoroborate (LiBF₄) can be dissolved in these.

### Electrolyte

In most cases, it is preferred that the cell comprises a liquid electrolyte which consists of a solvent or solvent mixture and a lithium ion-containing conducting salt and with which the separator is impregnated.

The cell preferably comprises an electrolyte which is a solvent or a solvent mixture from the group comprising acetonitrile (ACN), propylene carbonate (PC), γ-butyrolactone (GBL), adiponitrile (ADN), ethylene carbonate-diethyl carbonate (EC-DEC), ethylene carbonate-dimethyl carbonate (EC-DMC), ethylene carbonate-ethyl methyl carbonate (EC-EMC), ethylene carbonate-dimethyl carbonate-ethyl methyl carbonate (EC-DMC-EMC) and ethylene carbonate-dimethyl carbonate-diethyl carbonate (EC-DMC-DEC).

Further, it is preferred that the cell comprises an electrolyte containing a conducting salt selected from the group consisting of tetratethylammonium tetrafluoroborate (Et₄NBF₄), lithium hexafluorophosphate (LiPF₆), lithium hexafluoroarsenate (LiAsF₆), lithium tetrafluoroborate (LiBF₄), lithium perchlorate (LiClO₄), lithium bis(oxalato)borate (LiB(C₂O₄)₂) and LiP(C₆H₄O₂)₃.

The conductive salt is preferably contained in the electrolyte in a proportion of 0.5 M to 5 M, in particular 2 M.

In some preferred embodiments, the electrolyte comprises an additive selected from the group consisting of vinylene carbonate (VC) and fluoroethylene carbonate (FEC).

In a first, preferred variant, the cell is characterized by at least one of the following three additional features a. to c. with regard to the electrolyte:
a. The cell comprises an electrolyte containing acetonitrile (ACN) as a solvent.
b. The cell comprises an electrolyte, which comprises a conducting salt selected from the group consisting of tetratethylammonium tetrafluoroborate (Et₄NBF₄), lithium hexafluorophosphate (LiPF₆), lithium hexafluoroarsenate (LiAsF₆), lithium tetrafluoroborate (LiBF₄), lithium perchlorate (LiClO₄), lithium bis(oxalato)borate (LiB(C₂O₄)₂) and LiP(C₆H₄O₂)₃, in particular lithium tetrafluoroborate (LiBF₄).
c. The conductive salt is contained in the electrolyte in a concentration of 1.0 to 3.0 M, in particular 1.5 to 2.5 M.

Preferably, the three immediately preceding features a. to c. are realized in combination with one another.

In a second, preferred variant, the cell is characterized by at least one of the following four additional features a. to d. with regard to the electrolyte:
a. The cell comprises an electrolyte containing a mixture of propylene carbonate (PC) and γ-butyrolactone (GBL) as solvent.
b. The volume ratio of PC:to GBL in the mixture is in the range of 10:90 to 90:10, preferably it is 30:70.
c. The cell comprises an electrolyte, which comprises a conducting salt selected from the group consisting of tetratethylammonium tetrafluoroborate (Et₄NBF₄), lithium hexafluorophosphate (LiPF₆), lithium hexafluoroarsenate (LiAsF₆), lithium tetrafluoroborate (LiBF₄), lithium perchlorate (LiClO₄), lithium bis(oxalato)borate (LiB(C₂O₄)₂) and LiP(C₆H₄O₂)₃.
d. The conducting salt is contained in the electrolyte in a concentration of 0.5 to 5 M, in particular 2 M.

The four immediately preceding features a. to d. are preferably realized in combination with one another.

In a third, preferred variant, the cell is characterized by at least one of the following three additional features a. to c. with regard to the electrolyte:
a. The cell comprises an electrolyte containing propylene carbonate (PC) as a solvent.
b. The cell comprises an electrolyte, which comprises a conducting salt selected from the group consisting of tetratethylammonium tetrafluoroborate (Et₄NBF₄), lithium hexafluorophosphate (LiPF₆), lithium hexafluoroarsenate (LiAsF₆), lithium tetrafluoroborate (LiBF₄), lithium perchlorate (LiClO₄), lithium bis(oxalato)borate (LiB(C₂O₄)₂) and LiP(C₆H₄O₂)₃, in particular lithium hexafluorophosphate (LiPF₆).
c. The conducting salt is contained in the electrolyte in a concentration of 1.0 to 2.0 M.

The three immediately preceding features a. to c. are preferably realized in combination with one another.

In a fourth, preferred variant, the cell is characterized by at least one of the following five additional features a. to e. with regard to the electrolyte:
a. The cell contains an electrolyte comprising a mixture of ethylene carbonate (EC) and dimethyl carbonate (DMC) as solvent.
b. The volume ratio of EC:to DMC in the mixture is in the range of 1:7 to 5:7, preferably it is 3:7.
c. The cell comprises an electrolyte, which comprises a conducting salt selected from the group consisting of tetratethylammonium tetrafluoroborate (Et₄NBF₄), lithium hexafluorophosphate (LiPF₆), lithium hexafluoroarsenate (LiAsF₆), lithium tetrafluoroborate (LiBF₄), lithium perchlorate (LiClO₄), lithium bis(oxalate)borate (LiB(C₂O₄)₂) and LiP(C₆H₄O₂)₃, in particular lithium hexafluorophosphate (LiPF₆).
d. The conducting salt is contained in the electrolyte in a concentration of 1.0 to 2.0 M.
e. The electrolyte comprises vinylene carbonate (VC) as an additive, in particular in a concentration of 1 wt. % to 3 wt. %.

The five immediately preceding features a. to e. are preferably realized in combination with one another.

In a fifth, preferred variant, the cell is characterized with respect to the electrolyte by at least one of the six additional features a. to f. immediately below:
a. The cell comprises an electrolyte containing a mixture of ethylene carbonate (EC) and propylene carbonate (PC) and dimethyl carbonate (DMC) as solvents.
b. The proportions of the three components EC, PC and DMC in the electrolyte are 1:2:7 relative to each other.
c. The cell comprises an electrolyte, which comprises a conducting salt selected from the group consisting of tetratethylammonium tetrafluoroborate (Et₄NBF₄), lithium hexafluorophosphate (LiPF₆), lithium hexafluoroarsenate (LiAsF₆), lithium tetrafluoroborate (LiBF₄), lithium perchlorate (LiClO₄), lithium bis(oxalato)borate (LiB(C₂O₄)₂) and LiP(C₆H₄O₂)₃, in particular lithium hexafluorophosphate (LiPF₆).
d. The conducting salt is contained in the electrolyte in a concentration of 0.5 M to 5 M.
e. The cell comprises an electrolyte that includes tetraethylammonium tetrafluoroborate (Et₄NBF₄) as the co-conducting salt.
f. The co-conducting salt is contained in the electrolyte in a concentration of 0.1 M to 2 M.

The six immediately preceding features a. to f. are preferably realized in combination with one another.

The electrolyte according to the first variant has proven to be advantageous. The solvent acetonitrile is often used in the capacitor area for EDLCs. It is not generally used for lithium-ion cells as it is not stable under the usual electrochemical conditions. However, no problems arose in this respect in the present case. On the contrary, it was shown that the cell exhibited excellent cyclability with this electrolyte.

### Preferred Embodiments of the Separator

The cell is preferably characterized by the immediately following feature a:
a. The separator comprises at least one inorganic material that improves its resistance to thermal stress.

This material protects the separator from shrinkage as a result of localized heating, which can occur in particular when welding or soldering the contact sheet metal member. This considerably reduces the risk of a short circuit.

In a preferred further development, the cell is characterized by at least one of the immediately following features a. to c:
a. The electrode-separator assembly comprises a first separator and a second separator.
b. The first separator and the second separator are identical.
c. The electrode-separator assembly has the sequence anode/first separator/cathode/second separator or the sequence first separator/anode/second separator/cathode.

It is preferred that the immediately preceding features a. and c., and possibly also the immediately preceding features a. to c., are realized in combination with one another.

Preferably, both the first and the second separator are improved against thermal stresses by means of the at least one inorganic material.

In a preferred further development, the cell is characterized by the immediately following feature a:
a. The at least one inorganic material is contained in the separator, in particular the first separator and/or the second separator, as a particulate filling material.

The separator can therefore preferably be an electrically insulating plastic film in which the particulate filling material is embedded. It is preferable that the plastic film can be penetrated by the electrolyte, for example because it has micropores. The film can be made of a polyolefin or a polyether ketone, for example. It is not excluded that nonwovens and fabrics made of such plastic materials can also be used.

The proportion of particulate filler material in the separator is preferably at least 40% by weight, preferably at least 60% by weight.

In a further preferred further development, the cell is characterized by the immediately following feature a:
a. The at least one inorganic material is present as a coating on a surface of the separator, in particular the first separator and/or the second separator.

The separator can therefore preferably also be a plastic film or a nonwoven or a fabric or other electrically insulating sheet material that is coated with the particulate filling material.

In this case, separators with a base thickness in the range from 5 μm to 20 μm, preferably in the range from 7 μm to 12 μm, are preferably used. The above-mentioned preferred total thickness of the separators results from the base thickness and the thickness of the coating.

In some embodiments, only one side of the flat structure, in particular the plastic film, is coated with the inorganic material. In further embodiments, the sheet structure, in particular the plastic film, is preferably coated on both sides with the inorganic material.

The thickness of the coating is preferably in the range of 0.5 μm to 5 μm. This means that the total thickness of the separators in the case of a double-sided coating is preferably in the range from 6 μm to 30 μm, preferably in the range from 8 μm to 22 μm. In the case of a single-sided coating, the thickness is preferably in the range from 5.5 μm to 20.5 μm, preferably in the range from 7.5 μm to 17 μm.

Where appropriate, it may also be preferred that the separators used comprise an inorganic material as filler and the same or a different inorganic material as coating.

In further possible preferred embodiments, the cell is characterized by at least one of the immediately following features a. to e:
a. The at least one inorganic material is or comprises an electrically insulating material.
b. The at least one inorganic material is or comprises at least one material selected from the group consisting of ceramic material, glass-ceramic material and glass.
c. The at least one inorganic material is or comprises a lithium ion conducting ceramic material, for example Li₅AlO₄*Li₄SiO₄ oder LiAlSi₂O₆.
d. The at least one inorganic material is or comprises an oxidic material, in particular a metal oxide.
e. The ceramic or oxidic material is aluminum oxide (Al₂O₃), titanium oxide (TiO₂), titanium nitride (TiN), titanium aluminum nitride (TiAlN), a silicon oxide, in particular silicon dioxide (SiO₂) or titanium carbonitride (TiCN).

It is preferred that the immediately preceding features a. to c. or the immediately preceding features a. and b. and d. or the immediately preceding features a. and b. and e. are realized in combination with one another.

Among the materials mentioned, aluminum oxide (Al₂O₃), titanium oxide (TiO₂) and silicon dioxide (SiO₂) are preferred as coating materials.

In further possible preferred embodiments, the cell is characterized by at least one of the immediately following features a. to c:
a. The first separator and/or the second separator comprises the at least one inorganic material only in certain areas.
b. The first separator and/or the second separator has an edge strip along the first and/or the second longitudinal edge, in which it comprises the at least one inorganic material as a coating and/or as a particulate filler material.
c. The first separator and/or the second separator has a preferably band-shaped main region in which it is free of the at least one inorganic material.

It is preferred that the immediately preceding features a. to c. are realized in combination with one another.

It is by no means absolutely necessary for the separator to contain the inorganic material in a homogeneous distribution or to be evenly coated with the material everywhere. In fact, it may even be preferable for the separator to be free of the inorganic material in certain areas, for example in the main area mentioned. In this area, increased thermal resistance of the separator is not required as much as at the edges of the separator. In addition, the inorganic material can contribute to an unwanted increase in the internal resistance of the cell, particularly in this area.

### Preferred Structure of the Electrode-Separator Assembly Formed as a Coil

The strip-shaped anode, the strip-shaped cathode and the strip-shaped separator(s) are preferably spirally wound in the electrode-separator assembly formed as a coil. Preferably, to produce the electrode-separator assembly, the strip-shaped electrodes are fed together with the strip-shaped separator(s) to a winding device, where they are preferably wound in a spiral around a winding axis. Alternatively, the electrodes and the separators can also be combined to form the assembly and then wound up. In some embodiments, the electrodes and the separator are wound onto a cylindrical or hollow-cylindrical winding core for this purpose, which sits on a winding mandrel and remains in the coil after winding. The winding shell (shell of the coil) can be formed by a plastic film or an adhesive tape, for example. It is also possible for the winding shell to be formed by one or more separator windings.

It is preferable that the longitudinal edges of the separator or separators form the end faces of the electrode-separator assembly formed as a coil.

It is also preferred that the edge strips of the anode current collector and/or the cathode current collector emerging from the end faces of the coil do not protrude more than 5000 μm, preferably not more than 3500 μm, from the end faces.

Preferably, the edge strip of the anode current collector does not protrude more than 2500 μm, preferably not more than 1500 μm, from the end face of the coil. Preferably, the edge strip of the cathode current collector does not protrude more than 3500 μm, preferably not more than 2500 μm, from the end face of the coil.

Within the electrode-separator assembly, the anode and the cathode are preferably arranged offset to each other, so that the edge strip of the anode current collector emerges from one of the terminal end faces of the electrode-separator assembly and the edge strip of the cathode current collector emerges from the other terminal end face of the electrode-separator assembly.

### Current Collectors

It is preferred that the energy storage element comprises two metallic contact sheet metal members, one of which is in direct contact with the free edge strip of the anode current collector and the other with the free edge strip of the cathode current collector, in particular connected by welding or soldering.

The current collectors of the cell serve to electrically contact electrochemically active components contained in the respective electrode material over as large an area as possible. Preferably, the current collectors are made of a metal or are at least metallized on the surface. Suitable metals for the anode current collector include copper or nickel or other electrically conductive materials, in particular copper and nickel alloys or nickel-coated metals. Stainless steel is also an option. Aluminum or other electrically conductive materials, including aluminum alloys, are suitable metals for the cathode current collector. Stainless steel, for example type 1.4404, is also an option here.

Preferably, the anode current collector and/or the cathode current collector are each a metal foil with a thickness in the range from 4 μm to 30 μm, in particular a strip-shaped metal foil with a thickness in the range from 4 μm to 30 μm.

In preferred embodiments, the cell is characterized by at least one of the immediately following features a. and b:
a. The cathode current collector comprises or consists of aluminum or aluminum alloy.
b. The anode current collector comprises aluminum or aluminum alloy or is made of the aluminum or aluminum alloy.

It is preferred that the immediately preceding features a. and b. are realized in combination with one another.

In particular, the use of aluminum current collectors on the anode side, which results from the application of LTO/LMO electrochemistry, has advantages over the use of copper-based current collectors, for example. Since aluminum is lighter than copper, the energy density of the cell can be significantly increased. Furthermore, it has been shown that cells with aluminum foils as current collectors and LTO-based anodes are very stable against deep discharge. The tendency to form dendrites appears to be significantly reduced.

The surface of the current collectors, in particular the current collectors based on aluminum or the aluminum alloy, can preferably be coated with a carbon layer, in particular to reduce the contact resistance. The layer is preferably a few nm to a few μm thick and can be formed, for example, by deposition from the gas phase, for example by a CVD process (CVD=chemical vapor deposition), or a spraying process.

In addition to films, other strip-shaped substrates such as metallic or metallized nonwovens or open-pored metallic foams or expanded metals can also be used as current collectors.

The current collectors are preferably loaded with the respective electrode material on both sides. Accordingly, they preferably each have a strip-shaped main area that is loaded on both sides with a layer of the respective electrode material.

When an aluminum, copper or nickel alloy is mentioned in connection with the current collectors, this preferably refers to an alloy that has a content of at least 70% by weight, preferably at least 90% by weight, of the respective base metal aluminum, copper or nickel.

### Low-Material Design of the Current Collectors

In preferred embodiments, the cell is characterized by at least one of the immediately following features a. to c:
a. The strip-shaped main area of the current collector, which is preferably connected to the contact sheet metal member by welding or soldering, has a large number of openings.
b. The openings in the main area are round or square holes, in particular punched or drilled holes.
c. The current collector, which is preferably connected to the contact sheet metal member by welding or soldering, is perforated in the main area, in particular by round hole or slotted hole perforation.

Preferably, the immediately preceding features a. and b. or a. and c., preferably the three immediately preceding features a. to c., are realized in combination with one another.

The large number of openings results in a reduced volume and also in a reduced weight of the current collector. This makes it possible to introduce more active material into the cell and thus drastically increase the energy density of the cell. Energy density increases in the double-digit percentage range can be achieved in this way.

In some preferred embodiments, the openings are made in the strip-shaped main area using a laser.

In principle, the geometry of the openings is not essential. The introduction of the openings reduces the mass of the current collector and provides more space for active material, as the openings can be filled with the active material.

When inserting the openings, it can be very advantageous to ensure that the maximum diameter of the openings is not too large. Preferably, the dimensions of the openings should not be more than twice the thickness of the layer of electrode material on the respective current collector.

In preferred embodiments, the cell is characterized by the immediately following feature a:
a. The openings in the current collector, especially in the main area, have diameters in the range from 1 μm to 3000 μm.

Within this preferred range, diameters in the range from 10 μm to 2000 μm, preferably from 10 μm to 1000 μm, in particular from 50 μm to 250 μm, are further preferred.

Preferably, the cell is further characterized by at least one of the immediately following features a. and b:
a. The current collector, which is preferably connected to the contact sheet metal member by welding or soldering, has a lower weight per unit area than the free edge strip of the same current collector, at least in a section of the main area.
b. The current collector, which is preferably connected to the contact sheet metal member by welding or soldering, has no or fewer openings per unit area in the free edge strip than in the main area.

It is preferred that the immediately preceding features a. and b. are realized in combination with one another.

The openings are preferably distributed essentially evenly over the main area.

In further preferred embodiments, the cell is characterized by at least one of the immediately following features a. to c:
a. The weight per unit area of the current collector in the main area is reduced by 5% to 80% compared to the weight per unit area of the current collector in the free edge strip.
b. The current collector has a perforated area in the range of 5% to 80% in the main area.
c. The current collector has a tensile strength of 20 N/mm² to 250 N/mm² in the main area.

It is preferred that the immediately preceding features a. to c. are realized in combination with one another.

The perforated area, which is often also referred to as the free cross-section, can be determined in accordance with ISO 7806-1983. The tensile strength of the current collector in the main area is reduced compared to current collectors without the openings. It can be determined in accordance with DIN EN ISO 527 Part 3.

It is preferable that the anode current collector and the cathode current collector have the same or similar design with regard to the openings. The energy density improvements that can be achieved in each case add up. In preferred embodiments, the cell is therefore further characterized by at least one of the immediately following features a. to c:
a. The main strip-shaped area of the anode current collector and the main area of the cathode current collector are both characterized by a large number of the openings described above.
b. The cell comprises the contact sheet metal member, which is directly connected to one of the edge strips, as the first contact sheet metal member, as well as a second contact sheet metal member, which is directly connected to the other edge strip, in particular by welding or soldering.

It is preferred that the immediately preceding features a. and b. are realized in combination with one another.

The preferred embodiments of the current collector provided with the openings described above can be applied independently of one another to the anode current collector and the cathode current collector.

The use of perforated current collectors or current collectors with a large number of openings has not yet been seriously considered for lithium-ion cells, as such current collectors are very difficult to contact electrically. As mentioned at the beginning, the electrical connection of the current collectors is often made via separate arrester lugs. However, it is difficult to form a reliable welded connection between these arrester tabs and perforated current collectors in industrial mass production processes without an unacceptable error rate.

The problem can be solved by the described welding or soldering of the edge strips to the contact sheet metal member(s). This makes it possible to completely dispense with separate arrester lugs and thus enables the use of low-material current collectors provided with openings. In particular in embodiments in which the free edge strips of the current collectors are not provided with openings, welding or soldering can be carried out reliably with extremely low reject rates.

### Housing

In a preferred embodiment, the housing of the cell is characterized by at least one of the immediately following features a. and b:
a. The housing, which encloses the electrode-separator assembly, comprises a metallic, tubular housing part with a circular opening at the end.
b. In the housing, the electrode/separator assembly, which is designed as a coil, is axially aligned so that the winding shell rests against the inside of the tubular housing part.

It is preferred that the immediately preceding features a. and b. are realized in combination with one another.

### Housing Closure

Preferably, the cell is characterized by the two immediately following features a. and b:
a. The contact sheet metal member has a circular edge.
b. The contact sheet metal member closes the end circular opening of the tubular housing part.

A contact sheet metal member with a circular edge can be used as the contact sheet metal member and the contact sheet metal member can be used to close the end circular opening of the tubular housing part. The contact sheet metal member is therefore not only used here to make electrical contact with an electrode, it also functions as a housing part. This has a major advantage, as a separate electrical connection between the contact sheet metal member and a housing part is no longer required. This creates space within the housing and simplifies cell assembly. In addition, the direct connection of a housing part to the current collectors of a cell gives it excellent heat dissipation properties.

In a preferred further development, the cell is characterized by at least one of the four immediately following features a. to d:
a. The contact sheet metal member is a metal disk or is part of a cover assembly that includes a metal disk.
b. The metal disk is arranged in the tubular housing part in such a way that its edge rests against the inside of the tubular housing part along a circumferential contact zone.
c. The edge of the metal disk is connected to the tubular housing part by a circumferential weld or soldered seam.
d. One of the edge strips is connected to the metal disk by welding or soldering.

Preferably, all four immediately preceding features a. to d. are realized in combination with one another.

In some embodiments, the metal disk lies flat on the first longitudinal edge, resulting in a line-like contact zone which, in the case of the spirally wound electrodes, has a spiral shape. In further embodiments, the first longitudinal edge and thus also the edge strip can be bent or deformed.

So that the edge of the metal disk can rest against the inside of the tubular housing part along the circumferential contact zone, it is preferable for the tubular housing part to have a circular cross-section, at least in the section in which the edge of the metal disk rests. It is expedient for the section to be hollow cylindrical for this purpose. The inner diameter of the tubular housing part in this section is correspondingly adapted to the outer diameter of the edge of the metal disk.

Welding the edge of the metal disk to the tubular housing part can be carried out using a laser in particular. Alternatively, it would also be possible to fix the metal disk by soldering or bonding.

A separate sealing element is not required for a circumferential welded or soldered seam. The metal disk and the tubular housing part are connected to each other in a sealing manner via the welded or soldered seam. In addition, the welded or soldered connection also ensures a virtually resistance-free electrical connection between the metal disk and the tubular housing part. In this case, the metal disk and the tubular housing part have the same polarity.

In a further preferred further development, the cell is characterized by at least one of the four immediately following features a. to d:
a. The contact sheet metal member is a metal disk or is part of a cover assembly that includes a metal disk.
b. The cell comprises a ring-shaped seal made of an electrically insulating material, which surrounds the circular edge of the metal disk.
c. The metal disk is arranged in the tubular housing part in such a way that the ring-shaped seal rests against the inside of the tubular housing part along a circumferential contact zone.
d. One of the edge strips is connected to the metal disk by welding or soldering.

Preferably, all four immediately preceding features a. to d. are realized in combination with one another.

In this embodiment, it is therefore proposed to use a contact sheet metal member with a circular edge, to fit an annular seal made of an electrically insulating material to the circular edge of the contact sheet metal member and to use the contact sheet metal member to close the end circular opening of the tubular housing part. Alternatively, a cover assembly comprising a combination of the contact sheet metal member and a metal disk can be used instead of the contact sheet metal member. In this case, the seal is pulled onto the edge of the metal disk and the end circular opening of the tubular housing part is closed with the cover assembly.

The cell can be closed, for example, by crimping or crimping, whereby the seal is preferably compressed.

So that the annular seal can rest against the inside along the circumferential contact zone, it is also preferable here that the tubular housing part has a circular cross-section, at least in the section in which the seal rests. It is expedient for the section to be hollow cylindrical for this purpose. In this section, the inner diameter of the tubular housing part is correspondingly adapted to the outer diameter of the edge of the metal disk with the seal mounted on it.

The seal itself can be a standard plastic seal, which should be chemically resistant to the electrolytes used. Suitable sealing materials are known to the skilled person.

The closure variant with the ring-shaped seal made of the electrically insulating material means that the contact sheet metal member is electrically insulated from the tubular housing part. It forms an electrical pole of the cell. In the closure variant in which the edge of the metal disk is connected to the tubular housing part via a circumferential weld or soldered seam, the tubular housing part and the contact sheet metal member have the same polarity.

### Designs of the Metal Disk

The contact sheet metal member can be part of the aforementioned cover assembly, which in addition to the contact sheet metal member comprises the aforementioned metal disk and possibly other individual parts. In this case, the contact sheet metal member and the metal disk are preferably in contact with each other directly or via an electrical conductor. In some further preferred embodiments, the contact sheet metal member is the aforementioned metal disk.

In the simplest embodiment, the metal disk is a flat sheet metal part with a circular circumference that only extends in one plane. In many cases, however, more elaborate designs may also be preferred. For example, the metal disc can be profiled, e.g. have one or more circular depressions and/or elevations around its center, preferably in a concentric arrangement, which can result in a wave-shaped cross-section, for example. It is also possible for its inner side to have one or more ridges or linear depressions and/or elevations. Furthermore, the disk can have an edge that is bent radially inwards so that it has a double-layered edge area with a U-shaped cross-section, for example, or is bent radially by 90° so that an L-shaped cross-section results.

In a further development, the cell is characterized by at least one of the three immediately following features a. to c:
a. The metal disk has at least one groove-shaped and/or dot-shaped depression on one of its sides, which emerges on its other side as at least one linear and/or dot-shaped elevation.
b. The side with at least one elevation is in direct contact with the edge strip.
c. The at least one elevation and the edge strip are connected via at least one welding or soldering point and/or at least one welding or soldering seam.

The immediately preceding features a. to c. are preferably realized in combination.

The edge strip is therefore preferably welded or soldered directly to the at least one elevation.

In some embodiments, one of the edge strips may be bent or deformed by contact with the at least one elevation.

Furthermore, it may be preferred that beads are introduced as elongated depressions. In a preferred further development of the metal disc of the cell, it is characterized accordingly by at least one of the following two features a. and b:
a. The metal disk has several groove-shaped depressions on one of its sides, for example in a star-shaped arrangement, which emerge as linear elevations on its other side.
b. The metal disk comprises at least one weld or solder seam, preferably two parallel weld seams, in each of the groove-shaped depressions as a result of welding or soldering the metal disk to the edge strip.

The immediately preceding features a. and b. are preferably realized in combination.

The star-shaped arrangement and, if necessary, the double weld seam ensure a good and, above all, even connection of the metal disk to one of the edge strips.

### Multi-Part Cover Assembly

In a preferred further development, the cell is characterized by at least one of the immediately following features a. and b:
a. It comprises a cover assembly which, in addition to the contact sheet metal member, comprises the metal disk described above.
b. The contact sheet metal member is in direct contact with the edge strip and is connected to this edge strip by welding or soldering.

The immediately preceding features a. and b. are preferably realized in combination.

In this embodiment, the cover assembly therefore comprises at least two individual parts. The metal disk is used here to close the housing, while the contact sheet metal member makes contact with the edge strip of the current collector.

In some preferred embodiments, the contact sheet metal member can have a circular circumference, but this is by no means mandatory. In some cases, for example, the contact sheet metal member can be a metal strip or have several strip-shaped segments, for example in a star-shaped arrangement.

In some embodiments, a contact sheet metal member can be used that has at least one slot and/or at least one hole and/or at least one perforation. These can serve to counteract deformation of the contact sheet metal member when making a welded connection or a soldered connection to the edge strip.

Furthermore, the contact sheet metal member can have recesses such as holes or gaps, which serve the purpose of simplifying the distribution of the electrolyte during dosing and facilitating the escape of gases formed during formation or as a result of misuse or defects from the inside of the coil.

Preferably, the contact sheet metal member and the metal disk lie flat on top of each other, at least in some areas, so that a two-dimensional contact surface is created.

Preferably, the contact sheet metal member and the metal disk are in direct contact with each other. In this case, they are preferably fixed to each other by welding or soldering.

In preferred embodiments, the contact sheet metal member is designed like one of the contact sheet metal members described in WO 2017/215900 A1.

In a preferred embodiment, the cover assembly can comprise, in addition to the metal disk and possibly also in addition to the contact sheet metal member, a profiled metallic pole cover with a circular circumference, which can be welded or soldered onto the metal disk and has approximately or exactly the same diameter as the metal disk, so that the edge of the metal disk and the edge of the pole cover together form the edge of the cover assembly. In a further embodiment, the edge of the pole cover can be enclosed by a radially inwardly bent edge of the metal disk. In preferred embodiments, there may be a clamp connection between the two individual parts.

### Welding of the Contact Element to One of the Edge Strips

The concept of welding the edges of current collectors with contact elements is already known from WO 2017/215900 A1 or JP 2004-119330 A. This technology enables particularly high current carrying capacities and low internal resistance. With regard to methods for the electrical connection of contact elements, in particular also of disk-shaped contact elements, to the edges of current collectors, reference is therefore made in full to the content of WO 2017/215900 A1 and JP 2004-119330 A.

### Housing Variant With Housing Cup

As explained above, the housing of the cell is characterized in a preferred embodiment in that it comprises a metallic, tubular housing part with a circular opening at the end, wherein the contact sheet metal member comprises a circular edge and closes the circular opening at the end of the tubular housing part and one of the edge strips is connected to the contact sheet metal member by welding or soldering.

In a preferred further development, the cell is characterized by at least one of the following additional features a. and b. with regard to its housing:
a. The tubular housing part is part of a metal housing cup which has a circular base.
b. The other edge strip lies directly against the floor and is preferably connected to the floor by welding or soldering.

The immediately preceding features a. and b. are preferably realized in combination.

This variant is suitable for cells according to the closure variant described above with the ring-shaped seal made of the electrically insulating material.

The use of housing cups in the construction of cell housings has been known for a long time, for example from the WO 2017/215900 A1 mentioned at the outset. What is not known, however, is the direct connection of an edge strip of a current collector to the base of a housing cup, as proposed here.

According to the present disclosure, it is therefore possible and preferable to couple the edge strips of current collectors emerging from opposite end faces of an electrode-separator assembly formed as a coil directly to a housing part, namely the base of the cup and the contact sheet metal member described above, which acts as a closure element. The utilization of the available internal volume of the cell housing for active components thus approaches its theoretical optimum.

### Housing Materials

The choice of material from which the housing cup and the contact sheet metal member are made usually depends on whether they are in electrical contact with the anode or the cathode current collector. The same materials from which the current collectors themselves are made are generally preferred. The components mentioned can be made of the following materials, for example:

Alloyed or unalloyed aluminum, alloyed or unalloyed titanium, alloyed or unalloyed nickel, alloyed or unalloyed copper, stainless steel (e.g. type 1.4303 or 1.4404), nickel-plated steel.

Furthermore, the housing and its components can consist of multi-layer materials (clad materials), for example a layer of steel and a layer of aluminum or copper. In these cases, the layer of aluminum or the layer of copper forms the inside of the housing cup or the base of the housing cup, for example.

Other suitable materials are known to the person skilled in the art.

When an aluminum, copper or nickel alloy is mentioned in connection with the housing materials, this preferably refers to an alloy that has a content of at least 70% by weight, preferably at least 90% by weight, of the respective base metal aluminum, copper or nickel.

### Preferred Designs of the Electrodes

In the free edge strips, the metal of the respective current collector is preferably free of the respective electrode material. In some preferred embodiments, the metal of the respective current collector is uncovered there, so that it is available for electrical contacting, for example by the above-mentioned welding or soldering to the contact sheet metal member.

In some further embodiments, however, the metal of the respective current collector in the free edge strips can also be coated, at least in some areas, with a supporting material which is more thermally resistant than the current collector coated therewith and which differs from the electrode material arranged on the respective current collector.

“More thermally stable” here means that the support material retains its solid state at a temperature at which the metal of the current collector melts. It therefore either has a higher melting point than the metal or it sublimates or decomposes at a temperature at which the metal has already melted.

The support material can in principle be a metal or a metal alloy, provided that this or this has a higher melting point than the metal of which the surface that is coated with the supporting material consists. In many embodiments, however, the cell is preferably characterized by at least one of the immediately following additional features a. to d:
a. The support material is a non-metallic material.
b. The support material is an electrically insulating material.
c. The non-metallic material is a ceramic material, a glass-ceramic material or a glass.
d. The ceramic material is aluminum oxide (Al₂O₃), titanium dioxide (TiO₂), titanium nitride (TiN), titanium aluminum nitride (TiAlN), a silicon oxide, in particular silicon dioxide (SiO₂), or titanium carbonitride (TiCN).

The support material is preferably formed according to the immediately preceding feature b. and preferably according to the immediately preceding feature d.

The term non-metallic material includes in particular plastics, glass and ceramic materials.

The term electrically insulating material is to be interpreted broadly here. In principle, it includes any electrically insulating material, in particular the aforementioned plastics.

The term ceramic material is to be interpreted broadly here. In particular, it includes carbides, nitrides, oxides, silicides or mixtures and derivatives of these compounds.

The term “glass-ceramic material” refers in particular to a material comprising crystalline particles embedded in an amorphous glass phase.

The term “glass” basically means any inorganic glass that meets the thermal stability criteria defined above and is chemically stable against any electrolyte present in the cell.

The anode current collector is preferably made of copper or a copper alloy, while the cathode current collector is made of aluminum or an aluminum alloy and the support material is aluminum oxide or titanium oxide.

It may also be preferable for free edge strips of the anode and/or cathode current collector to be coated with a strip of the supporting material.

The main areas, in particular the strip-shaped main areas of the anode current collector and cathode current collector, preferably extend parallel to the respective edges or longitudinal edges of the current collectors. Preferably, the strip-shaped main areas extend over at least 90%, preferably over at least 95%, of the areas of the anode current collector and cathode current collector.

In some preferred embodiments, the support material is applied directly next to the preferably strip-shaped main areas in the form of a strip or a line, but does not completely cover the free areas, so that the metal of the respective current collector is exposed directly along the longitudinal edge.

### Other Preferred Embodiments of the Cell

The cell can be a button cell. Button cells are cylindrical in shape and have a height that is smaller than their diameter. Preferably, the height is in the range of 4 mm to 15 mm. It is also preferred that the button cell has a diameter in the range of 5 mm to 25 mm. Button cells are suitable, for example, for supplying small electronic devices such as watches, hearing aids and wireless headphones with electrical energy.

The nominal capacity of a button cell designed as a lithium-ion cell is generally up to 1500 mAh. Preferably, the nominal capacity is in the range of 100 mAh to 1000 mAh, preferably in the range of 100 to 800 mAh.

However, the cell is preferably a cylindrical round cell. Cylindrical round cells have a height that is greater than their diameter. They are suitable for the aforementioned applications with high energy requirements, for example in the automotive sector or for e-bikes or power tools.

The height of cells designed as round cells is preferably in the range of 15 mm to 150 mm. The diameter of the cylindrical round cells is preferably in the range of 10 mm to 60 mm. Within these ranges, form factors of, for example, 18×65 (diameter times height in mm) or 21×70 (diameter times height in mm) are preferred. Cylindrical round cells with these form factors are suitable for supplying power to electric drives in motor vehicles.

The nominal capacity of the cylindrical round cell, which is designed as a lithium-ion cell, is preferably up to 90000 mAh. With the form factor of 21×70, the cell in one embodiment as a lithium-ion cell preferably has a nominal capacity in the range from 1500 mAh to 7000 mAh, preferably in the range from 3000 to 5500 mAh. With the form factor of 18×65, the cell in one embodiment as a lithium-ion cell preferably has a nominal capacity in the range from 1000 mAh to 5000 mAh, preferably in the range from 2000 to 4000 mAh.

In the European Union, manufacturer information on the nominal capacity of secondary batteries is strictly regulated. For example, information on the nominal capacity of secondary nickel-cadmium batteries must be based on measurements in accordance with the IEC/EN 61951-1 and IEC/EN 60622 standards, information on the nominal capacity of secondary nickel-metal hydride batteries must be based on measurements in accordance with the IEC/EN 61951-2 standard, information on the nominal capacity of secondary lithium batteries must be based on measurements in accordance with the IEC/EN 61960 standard and information on the nominal capacity of secondary lead-acid batteries must be based on measurements in accordance with the IEC/EN 61056-1 standard. Any information on nominal capacities in the present application is preferably also based on these standards.

In embodiments in which the cell is a cylindrical round cell, the anode current collector, the cathode current collector and the separator are preferably ribbon-shaped and preferably have the following dimensions:
A length in the range from 0.5 m to 25 m
A width in the range 30 mm to 145 mm

The free edge strip, which extends along the first longitudinal edge and which is not loaded with the electrode material, preferably has a width of no more than 5000 μm in these cases.

In the case of a cylindrical round cell with a form factor of 18×65, the current collectors preferably have
a width of 56 mm to 62 mm, preferably 60 mm, and
a length of no more than 2 m, preferably no more than 1.5 m.

In the case of a cylindrical round cell with a form factor of 21×70, the current collectors preferably have
a width of 56 mm to 68 mm, preferably 65 mm, and
a length of no more than 3 m, preferably no more than 2.5 m.

In a preferred embodiment, the cell is characterized by the following additional feature:
a. The contact sheet metal member or the cover assembly with the contact sheet metal member includes a safety valve through which pressure can escape from the housing if a further pressure threshold value is exceeded.

This safety valve can, for example, be a bursting membrane, a bursting cross or a similar predetermined cracking point, which can rupture at a defined overpressure in the cell in order to prevent the cell from exploding. For example, the metal disk of the cover assembly can have the safety valve, in particular in the form of a predetermined cracking point.

### Prismatic Design

The present disclosure also provides energy storage elements comprising a stack of a plurality of anodes and a plurality of cathodes enclosed in a prismatic housing.

In particular, the energy storage element includes the immediately following features a. to k.:
a. It comprises a plurality of anodes and cathodes,
b. the anodes each comprise an anode current collector and a negative electrode material,
c. the anode current collectors each have
a main area loaded with a layer of the negative electrode material, and
a free edge strip which extends along one edge of the anode current collectors and which is not loaded with the negative electrode material,
d. the cathodes each comprise a cathode current collector and a positive electrode material,
e. the cathode current collectors each have
a main area loaded with a layer of the positive electrode material, and
a free edge strip which extends along one edge of the cathode current collectors and which is not loaded with the positive electrode material,
f. the anodes and cathodes are stacked, whereby the anodes and cathodes in the stack are separated by separators or layers of a solid-state electrolyte,
g. the stack is enclosed in a prismatic housing,
h. the free edge strips of the anode current collectors protrude from one side of the stack and the free edge strips of the cathode current collectors protrude from another side of the stack,
i. the energy storage element has a contact sheet metal member which is in direct contact with the free edge strips of the anode current collectors and/or the cathode current collectors,
j. the layer of negative electrode material comprises lithium titanate (LTO) and
k. the layer of positive electrode material comprises lithium manganese oxide (LMO).

The same preferred embodiments apply to the layer of negative electrode material, the layer of positive electrode material, the current collectors and the separator as in the case of the lithium-ion cell. The same applies to the electrolyte, if the energy storage element has one.

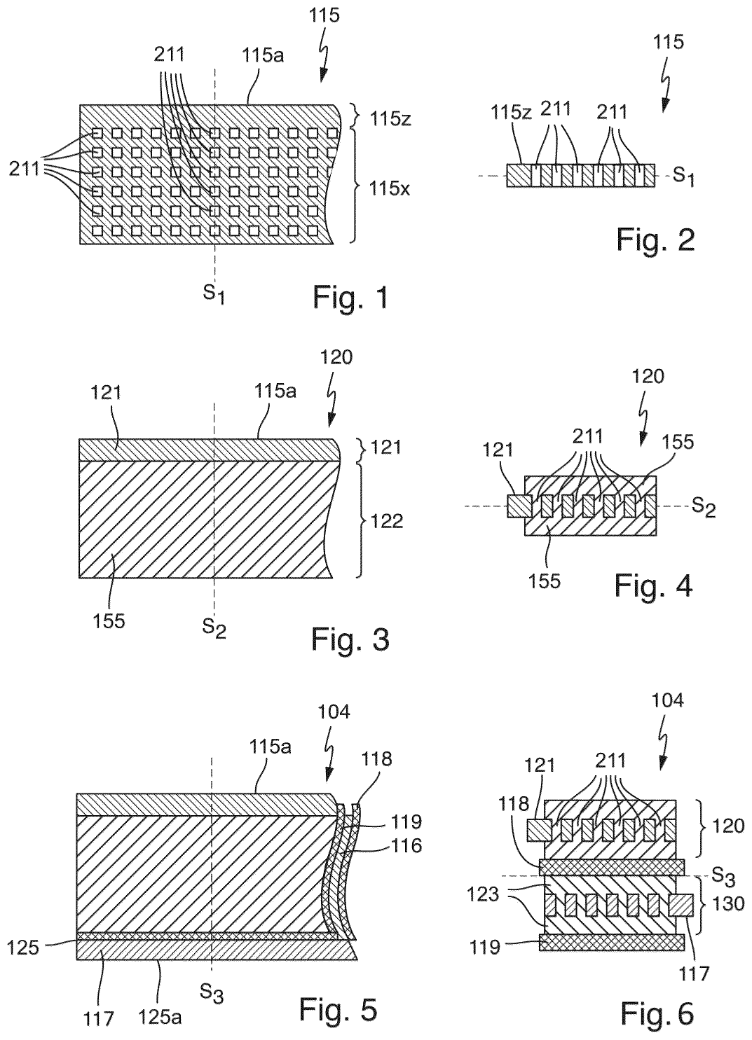

FIG. 1 and FIG. 2 illustrate the design of a current collector 115 that can be used in a cell. FIG. 2 is a sectional view along S₁. The current collector 115 comprises a plurality of openings 211, which are rectangular holes. The area 115x is characterized by the openings 211, whereas there are no openings in the area 115z along the longitudinal edge 115a. The current collector 115 therefore has a significantly lower weight per unit area in the area 115x than in the area 115z.

FIG. 3 and FIG. 4 illustrate an anode 120 which was manufactured by applying a negative electrode material 155 to both sides of the current collector 115 shown in FIG. 1 and FIG. 2. FIG. 4 is a section along S₂. The current collector 115 now has a strip-shaped main area 122, which is loaded with a layer of the negative electrode material 123, as well as a free edge strip 121, which extends along the longitudinal edge 115a and which is not loaded with the electrode material 155. The electrode material 155 also fills the openings 211.

FIG. 5 and FIG. 6 illustrate an electrode-separator assembly 104 that was manufactured using the anode 120 shown in FIG. 3 and FIG. 4. It also includes the cathode 130 and the separators 118 and 119. FIG. 6 is a sectional view along S₃. The cathode 130 is based on the same current collector design as the anode 120. Preferably, the current collectors 115 and 125 of the anode 120 and cathode 130 are both made of aluminum. The current collector 125 of the cathode 130 comprises a strip-shaped main region 116 loaded with a layer of positive electrode material 123 and a free edge strip 117 extending along the longitudinal edge 125a, which is not loaded with the electrode material 123. The electrode-separator assembly 104 is preferably in the form of a spiral winding and can be contained in a cell.

In some preferred embodiments, the free edge strips 117 and 121 are coated on both sides and at least in some areas with an electrically insulating support material, for example with a ceramic material such as silicon or aluminum oxide.

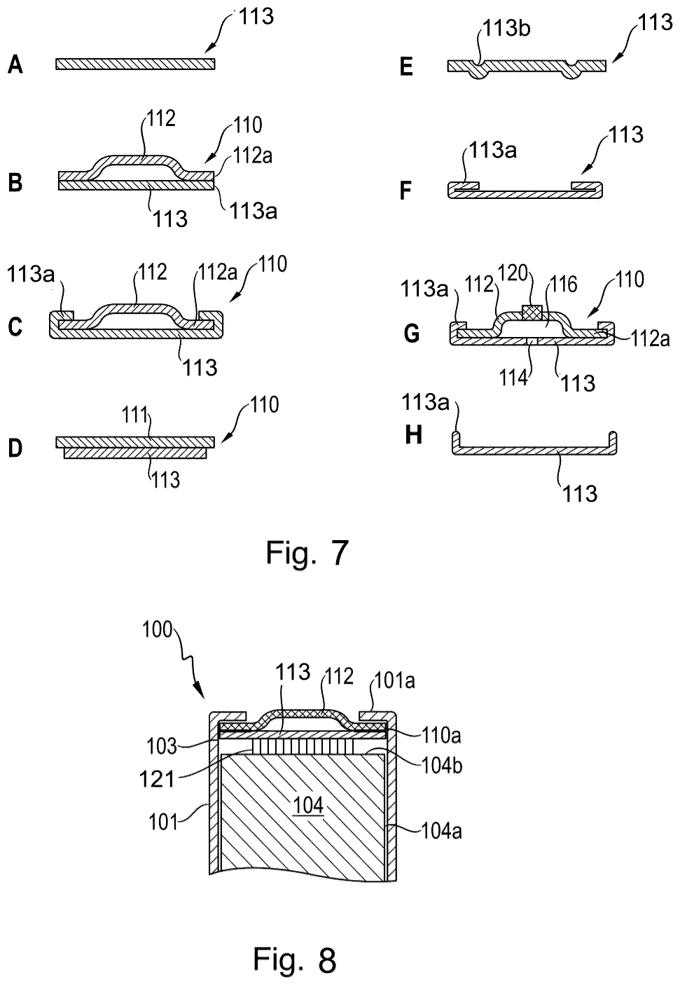

FIG. 7 shows cross-sectional views of various embodiments A to H of contact sheet metal members and cover assemblies that are suitable for closing cells 100. In detail:
A The simplest embodiment of a contact sheet metal member 113 is shown here, namely a flat metal disk with a circular circumference which only extends in one plane. The metal disk can be made of aluminum, for example.
B The cover assembly 110 shown here comprises the contact sheet metal member 113 in the form of a metal disc and the metal pole cover 112. The contact sheet metal member 113 and the pole cover 112 each have a circular circumference and an identical diameter. While the contact sheet metal member 113 only extends in one plane, the pole cover 112 has a central curvature. The two components 112 and 113 of the cover assembly 110 are preferably joined together by welding or soldering (not shown).
C The cover assembly 110 shown here comprises the contact sheet metal member 113 designed as a metal disk and the metal pole cover 112. The pole cover 112 is designed in the same way as the pole cover in B. However, the edge 113a of the contact sheet metal member 113 is bent radially inwards here, so that the contact sheet metal member 113 has a U-shaped cross-section in the edge area. The bent edge 113a encloses the edge 112a of the pole cover 112 and thus fixes the pole cover 112 on the contact sheet metal member 113. Regardless of this, it is preferred if the contact sheet metal member and the pole cover 112 are additionally welded or soldered together.

The cover assembly 110 shown here comprises the contact sheet metal member 113 in the form of a metal disk and the metal disk 112. The contact sheet metal member 113 lies flat against the metal disk 112 and is preferably welded or soldered to it. The metal disk 112 can be made of stainless steel, for example, and the contact sheet metal member 113 can be made of an aluminum alloy, for example.

The contact sheet metal member 113 shown here is designed as a metal disk. In contrast to the metal disk shown in A, this has a circular depression 113b on its upper side and a corresponding elevation on its underside, i.e. it is profiled.
F The contact sheet metal member 113 shown here comprises only a metal disk. In contrast to the metal disk shown in A, this has a radially inwardly folded edge 113a and subsequently a double-layered edge area.
G The cover assembly 110 shown here comprises the contact sheet metal member 113 in the form of a metal disk and the metal pole cover 112, which has a central curvature. The edge 113a of the contact sheet metal member 113 is bent radially inwards so that the contact sheet metal member 113 has a U-shaped cross-section in the edge area. The bent edge 113a surrounds the edge 112a of the pole cover 112 and thus fixes the pole cover 112 on the contact sheet metal member 113. Preferably, the edges 131a and 112a of the contact sheet metal member 113 and the pole cover 112 are additionally joined together by a circumferential weld or solder seam (not shown). In the center of the contact sheet metal member 113 is the hole 114, through which a cavity 116 is accessible, which is enclosed by the contact sheet metal member 113 and the pole cover 112. An overpressure safety device 120 is integrated into the pole cover 112, which can be triggered in the event of overpressure in the cavity 116. In the simplest case, the overpressure protection 120 can be a predetermined cracking point.
H The contact sheet metal member 113 shown here is designed as a metal disk. It has a 90° bent edge 113a with an L-shaped cross-section.

Closure elements, which can be used as part of the housing variant with two lids described above, can preferably also be designed according to embodiments A to H.

The cell 100 shown in FIG. 8 comprises the cover assembly 110 shown in FIG. 7B, the edge 110a of which is formed by the edges 113a and 112a of the contact sheet metal member 113, which is formed as a metal disk, and the metal pole cover 112. Together with the housing part 101, the cover assembly 110 forms the housing of the cell 100 and closes an end opening of the housing part 101. The edge 110a of the cover assembly 110 lies along a circumferential contact zone on the inside 101b of the tubular housing part 101 and is connected to the tubular housing part 101 via a circumferential weld or solder seam. The edge 101a of the housing part 101 is bent radially inwards over the edge 110a of the cover assembly 110.

The spirally wound electrode-separator assembly 104 is axially aligned in the housing so that its winding shell 104a rests against the inside of the tubular housing part 101. The edge strip 121 of the anode current collector, which is not covered with electrode material, emerges from the upper end face 104b of the electrode-separator assembly 104, which is formed as a coil. This is welded or soldered directly to the underside of the contact sheet metal member 113.

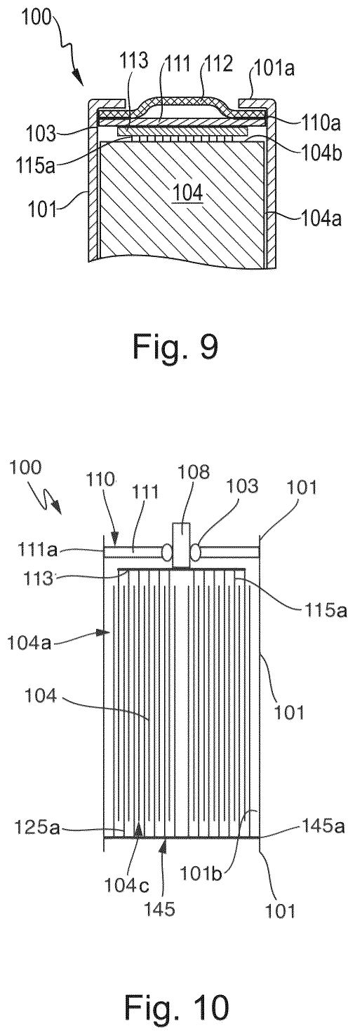

The cell 100 shown in FIG. 9 comprises a cover assembly analogous to that shown in FIG. 1B, but with one difference. In the cover assembly 110 shown here, the metal disk 111 resting against the pole cover 112 is not used for contacting the anode current collectors. For this purpose, it comprises the metal contact sheet metal member 113, which has two sides, one of which points in the direction of the metal disk 111, even lies flat against it, and is connected to the metal disk 111 by welding or soldering. The free edge strip 121 of the anode current collector emerges from the top end 104b of the electrode-separator assembly 104, which is formed as a coil. This lies directly against the underside of the contact sheet metal member 113 and is welded or soldered to the underside of the contact sheet metal member 113.

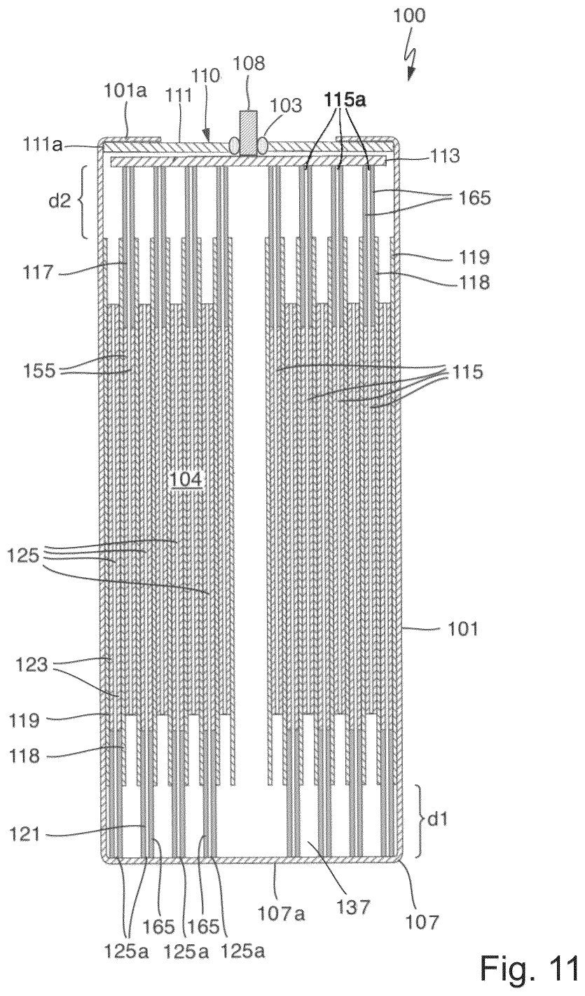

The cell 100 shown in FIG. 10 comprises the electrode-separator assembly 104, which is inserted axially into the hollow cylindrical housing part 101 so that its winding shell 104a rests against the inside 101b of the tubular housing part 101. The electrode-separator assembly 104 comprises a ribbon-shaped anode and a ribbon-shaped cathode, which are wound in a spiral. The anode comprises a ribbon-shaped anode current collector and a ribbon-shaped cathode current collector. The anode current collector is loaded with a layer of negative electrode material. The cathode current collector is loaded with a layer of positive electrode material.

The free edge strip 121 of the anode current collector emerges from the top end 104b of the electrode-separator assembly 104, which is formed as a coil. The free edge strip 117 of the cathode current collector emerges from the bottom end 104c of the electrode-separator assembly 104, which is formed as a coil.

The cell 100 comprises the tubular and hollow cylindrical metal housing part 101, which has two end openings. The opening at the top is closed by the metal disk 111, which is arranged in the tubular housing part 101 in such a way that its edge 111a rests against the inside 101b of the tubular housing part 101 along a circumferential contact zone. The edge 111a of the metal disk 111 is connected to the tubular housing part 101 via a circumferential welded or soldered seam.

The metal disk 111 is part of a cover assembly 110 which, in addition to the metal disk 111, comprises the contact sheet metal member 113 and the pole pin 108. The contact sheet metal member 113 has two sides, one of which, the top side in the picture, faces in the direction of the metal disk 111. The longitudinal edge 115a lies directly against the other side of the contact sheet metal member 113, in this case the lower side. The longitudinal edge 115a is connected to the contact sheet metal member 113 by welding or soldering. The pole pin 108 is welded or soldered to the contact sheet metal member 113 and is led out of the housing of the cell 100 through a central aperture in the metal disk 111.

The cover assembly 110 further comprises the insulating means 103, which electrically insulates the pole pin 108 and thus also the contact sheet metal member 113, which is welded or soldered to the pole pin, against the metal disk 111.

The bottom opening of the housing part 101 is closed with the closing element 145. The closure element 145 is a metal disk, the edge 145a of which rests against the inside 101b of the tubular housing part 101 along a circumferential contact zone. The edge 145a of the closure element 145 is connected to the tubular housing part 101 via a circumferential welded or soldered seam.

The longitudinal edge 125a of the cathode current collector lies directly against the inner (upper) side of the contact sheet metal member 113. The longitudinal edge 125a is connected to the closure element 145 by welding or soldering. The welding can be effected, for example, by means of a laser through the metal disk of the closure element 145.

The cell 100 shown in FIG. 11 comprises a hollow cylindrical housing part 101, which is part of the housing cup 107, which comprises the circular base 107a and a circular opening (defined by the rim 101a). The housing cup 107 is a deep-drawn part. Together with the lid assembly 110, which comprises the flat metal disk 111 with the circular rim 111a, the housing cup 107 encloses an interior 137 in which the electrode-separator assembly 104, which is formed as a coil, is axially aligned. The metal disk 111 is arranged in the tubular housing part 101 in such a way that its edge 111a rests against the inside 101b of the tubular housing part 101 along a circumferential contact zone. Its edge 111a corresponds to the edge of the cover assembly and is connected to the tubular housing part 101 via a circumferential weld or solder seam. The edge 101a of the tubular housing part 101 is bent radially (here by approx. 90°) inwards over the edge 111a of the metal disk 111.

The electrode-separator assembly 104 is in the form of a cylindrical coil with two end faces, between which the circumferential winding shell extends, which rests against the inside of the hollow cylindrical housing part 101. It is made up of a positive electrode and a negative electrode as well as the separators 118 and 119, which are each formed as a strip and wound in a spiral. The two end faces of the electrode-separator assembly 104 are formed by the longitudinal edges of the separators 118 and 119. The current collectors 115 and 125, which are both made of aluminum, protrude from these end faces. The corresponding protrusions are labeled d1 and d2.

The anode current collector 115 emerges from the upper end face of the electrode-separator assembly 104, and the cathode current collector 125 emerges from the lower end face. The anode current collector 115 is loaded with a layer of a negative electrode material 155 in a strip-shaped main region. The cathode current collector 125 is loaded in a strip-shaped main region with a layer of a positive electrode material 123. The anode current collector 115 has an edge strip 117 which extends along its longitudinal edge 115a and which is not loaded with the electrode material 155. Instead, a coating 165 of a ceramic support material is applied here, which stabilizes the current collector in this area. The cathode current collector 125 has an edge strip 121 which extends along its longitudinal edge 125a and which is not loaded with the electrode material 123. Instead, the coating 165 of the ceramic support material is also applied here.

In addition to the metal disk 111, the cover assembly 110 also comprises the contact sheet metal member 113 and the pole pin 108. The metal contact sheet metal member 113 comprises two sides, one of which, in the figure the upper side, points in the direction of the metal disk 111. On the other side of the contact sheet metal member 113, here the lower side, the longitudinal edge 115a is in direct contact over its entire length with the contact sheet metal member 113 and thus with the cover assembly 110 and is connected to the latter by welding or soldering over at least several sections, preferably over its entire length. Alternatively, the multi-pin connection described above may be present here. The cover assembly 110 thus serves simultaneously as an electrical contact for the anode and as a housing part.

The pole pin 108 is welded or soldered to the contact sheet metal member 113 and led out of the housing of the cell 100 through a central aperture in the metal disk 111. The cover assembly 110 also comprises the insulating means 103, which electrically insulates the pole pin 108 and thus also the contact sheet metal member 113, which is welded or soldered to the pole pin, from the metal disk 111. Only the metal disk 111 is in direct and therefore also in electrical contact with the housing cup 107. The pole pin 108 and the contact sheet metal member 113 are insulated from the housing cup.

The edge 125a of the cathode current collector 125 is in direct contact with the base 107a over its entire length and is connected to the latter at least over several sections, preferably over its entire length, by welding (in particular with the aid of a laser) or soldering. Alternatively, the multi-pin connection described above can also be used here. The base 107a thus serves not only as part of the housing but also for the electrical contacting of the cathode.

The electrode-separator assembly 104 may comprise, for example, a positive electrode comprising 95 wt % LMO, 2 wt % of an electrode binder and 3 wt % carbon black as a conductive agent. The anode 101 may comprise, for example, a negative electrode comprising 95 wt % LTO, 2 wt % of an electrode binder and 3 wt % carbon black as a conductive agent. A 2 M solution of lithium tetrafluoroborate (LiBF₄) in acetonitrile can be used as the electrolyte.

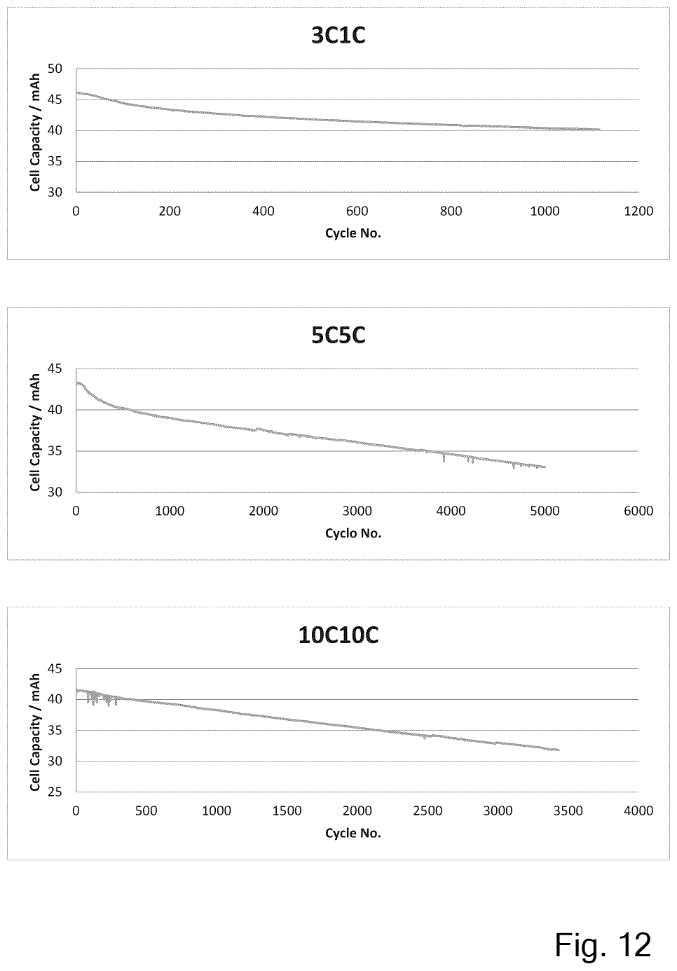

The diagrams shown in FIG. 12 illustrate the good cyclability of the cell. At a load of 10 C (charging)/10 C (discharging), almost 80% of the initial capacity was still achieved after 5000 cycles. Even at loads of 3 C/1 C and 5 C/5 C, 1000 and 2500 cycles were achieved stably.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A secondary lithium-ion cell, comprising:
a ribbon-shaped anode comprising a negative electrode material and a ribbon-shaped anode current collector, the anode current collector comprising a first longitudinal edge, a second longitudinal edge, a strip-shaped main region loaded with a layer of the negative electrode material, and a free edge strip that extends along the first longitudinal edge and is not loaded with the negative electrode material;
a ribbon shaped cathode comprising a positive electrode material and a ribbon-shaped cathode current collector, the cathode current collector comprising a first longitudinal edge, a second longitudinal edge,-a strip-shaped main region loaded with a layer of the positive electrode material, and a free edge strip that extends along the first longitudinal edge and is not loaded with the positive electrode material; and
a contact sheet metal member in direct contact with the free edge strip of the anode current collector or with the free edge strip of the cathode current collector,
wherein the anode and the cathode are provided in an electrode-separator assembly with a sequence anode/separator/cathode, the electrode-separator assembly forming a coil with two terminal end faces and being enclosed in a housing,
wherein the anode and the cathode are arranged within the electrode-separator assembly such that the free edge strip of the anode current collector emerges from one of the terminal end faces and the free edge strip of the cathode current collector emerges from the other of the terminal end faces,
wherein the negative electrode material comprises lithium titanate (LTO), and
wherein the positive electrode material comprises lithium manganese oxide (LMO).

2. The cell according to claim 1, wherein the cathode current collector comprises aluminum or aluminum alloy, and
wherein the anode current collector comprises aluminum or aluminum alloy.

3. The cell according to claim 1, wherein at least one of:
the positive electrode material comprises the LMO in a proportion of 70 wt % to 99.4 wt %,
the positive electrode material comprises an electrode binder and/or a conductive agent,
the electrode binder is contained in the positive electrode material in a proportion of 0.5% to 15% by weight, or
the conductive agent is contained in the positive electrode material in a proportion of 0.1 wt. % to 15 wt. %.

4. The cell according to claim 1, wherein the layer of positive electrode material on the cathode current collector has a thickness in a range of 20 to 300 μm.

5. The cell according to claim 1, wherein at least one of:
the negative electrode material comprises the LTO in a proportion of 70 wt. % to 99.4 wt. %,
the negative electrode material comprises an electrode binder and/or a conductive agent,
the electrode binder is contained in the negative electrode material in a proportion of 0.5% to 15% by weight, or
the conductive agent is contained in the negative electrode material in a proportion of 0.1% to 15% by weight.

6. The cell according to claim 1, wherein the layer of negative electrode material on the anode current collector has a thickness in a range of 20 μm to 300 μm μm.

7. The cell according to claim 1, further comprising an electrolyte:
wherein:
the electrolyte is a solvent or a solvent mixture selected from the group consisting of: acetonitrile (ACN), propylene carbonate (PC), γ-butyrolactone (GBL), adiponitrile (ADN), ethylene carbonate-diethyl carbonate (EC-DEC), ethylene carbonate-dimethyl carbonate (EC-DMC), ethylene carbonate-ethyl methyl carbonate (EC-EMC), ethylene carbonate-dimethyl carbonate-ethyl methyl carbonate (EC-DMC-EMC), and ethylene carbonate-dimethyl carbonate-diethyl carbonate (EC-DMC-DEC),
the electrolyte comprises a conducting salt selected from the group consisting of: tetratethylammonium tetrafluoroborate (Et₄NBF₄), lithium hexafluorophosphate (LiPF₆), lithium hexafluoroarsenate (LiAsF₆), lithium tetrafluoroborate (LiBF₄), lithium perchlorate (LiClO₄), lithium bis(oxalato)borate (LiB(C₂O₄)₂), and LiP(C₆H₄O₂)₃, or
the electrolyte comprises an additive selected from the group consisting of: vinylene carbonate (VC) and fluoroethylene carbonate (FEC).

8. The cell according to claim 1, further comprising an electrolyte:
wherein the electrolyte comprises acetonitrile (ACN) as a solvent,
wherein the electrolyte comprises a conducting salt selected from the group consisting of: tetratethylammonium tetrafluoroborate (Et₄NBF₄), lithium hexafluorophosphate (LiPF₆), lithium hexafluoroarsenate (LiAsF₆), lithium tetrafluoroborate (LiBF₄), lithium perchlorate (LiClO₄), lithium bis(oxalato)borate (LiB(C₂O₄)₂), and LiP(C₆H₄O₂)₃, and
wherein the conducting salt is contained in the electrolyte in a concentration of 1.0 to 3.0 M.

9. The cell according to claim 1, further comprising an electrolyte:
wherein the electrolyte comprises a mixture of propylene carbonate (PC) and γ-butyrolactone (GBL) as a solvent,
wherein a volume ratio of PC to GBL in the mixture is in a range of 10:90 to 90:10,
wherein the electrolyte comprises a conducting salt selected from the group consisting of: tetratethylammonium tetrafluoroborate (Et₄NBF₄), lithium hexafluorophosphate (LiPF₆), lithium hexafluoroarsenate (LiAsF₆), lithium tetrafluoroborate (LiBF₄), lithium perchlorate (LiClO₄), lithium bis(oxalato)borate (LiB(C₂O₄)₂), and LiP(C₆H₄O₂)₃, and
wherein the conducting salt is contained in the electrolyte in a concentration of 0.5 M to 5 M.

10. The cell according to claim 1, further comprising an electrolyte,
wherein the electrolyte comprises propylene carbonate (PC) as a solvent,
wherein the electrolyte comprises a conducting salt selected from the group consisting of: tetratethylammonium tetrafluoroborate (Et₄NBF₄), lithium hexafluorophosphate (LiPF₆), lithium hexafluoroarsenate (LiAsF₆), lithium tetrafluoroborate (LiBF₄), lithium perchlorate (LiClO₄), lithium bis(oxalato)borate (LiB(C₂O₄)₂), and LiP(C₆H₄O₂)₃, in particular lithium hexafluorophosphate (LiPF₆), and
wherein the conducting salt is contained in the electrolyte in a concentration of 1.0 to 2.0 M.

11. The cell according to claim 1, further comprising an electrolyte,
wherein the cell comprises an electrolyte containing a mixture of ethylene carbonate (EC) and dimethyl carbonate (DMC) as a solvent,
wherein a volume ratio of EC to DMC in the mixture is in a range of 1:7 to 5:7,
wherein the electrolyte comprises a conducting salt selected from the group consisting of: tetratethylammonium tetrafluoroborate (Et₄NBF₄), lithium hexafluorophosphate (LiPF₆), lithium hexafluoroarsenate (LiAsF₆), lithium tetrafluoroborate (LiBF₄), lithium perchlorate (LiClO₄), lithium bis(oxalato)borate (LiB(C₂O₄)₂), and LiP(C₆H₄O₂)₃,
wherein the conducting salt is contained in the electrolyte in a concentration of 1.0 to 2.0 M, and
wherein the electrolyte comprises vinylene carbonate (VC) as an additive.

12. The cell according to claim 1, further comprising an electrolyte,
wherein the electrolyte comprises a mixture of ethylene carbonate (EC) and propylene carbonate (PC) and dimethyl carbonate (DMC) as solvents,
wherein the proportions of the three components EC, PC and DMC in the electrolyte are 1:2:7 relative to each other,
wherein the electrolyte comprises a conducting salt selected from the group consisting of: tetratethylammonium tetrafluoroborate (Et₄NBF₄), lithium hexafluorophosphate (LiPF₆), lithium hexafluoroarsenate (LiAsF₆), lithium tetrafluoroborate (LiBF₄), lithium perchlorate (LiClO₄), lithium bis(oxalato)borate (LiB(C₂O₄)₂), and LiP(C₆H₄O₂)₃,
wherein the conducting salt is contained in the electrolyte in a concentration of 0.5 M to 5 M,
wherein the electrolyte comprises tetraethylammonium tetrafluoroborate (Et₄NBF₄) as a co-conducting salt, and
wherein the co-conducting salt is contained in the electrolyte in a concentration of 0.1 M to 2 M.

13. The cell according to claim 7, wherein the electrolyte comprises the conducting salt, and wherein the conducting salt is contained in the electrolyte in a proportion of 0.5 M to 5 M.

14. The cell according to claim 13, wherein the conducting salt is contained in the electrolyte in a proportion of 2 M.

15. The cell according to claim 8, wherein the conducting salt is lithium tetrafluoroborate (LiBF₄).

16. The cell according to claim 11, wherein the conducting salt is lithium hexafluorophosphate (LiPF₆).

17. The cell according to claim 12, wherein the conducting salt is lithium hexafluorophosphate (LiPF₆).
